(19) United States
(12) Patent Application Publication
(10) Pub. No.: US 2026/0203823 A1
(43) Pub. Date: Jul. 16, 2026

(54) SYSTEM AND METHOD FOR FACILITATING FRACTIONAL INVESTMENT IN REAL PROPERTY THROUGH MULTIPLE UNRELATED PARTIES

(71) Applicant: Respace, Inc., Seattle, WA (US)

(72) Inventors: Katrina Romatowski, Seattle, WA (US); Rick Romatowski, Seattle, WA (US)

(21) Appl. No.: 19/563,720

(22) Filed: Mar. 11, 2026

Related U.S. Application Data
(63) Continuation-in-part of application No. 18/646,029, filed on Apr. 25, 2024, now abandoned.

(51) Int. Cl. G06Q 40/06; G06Q 40/04; G06Q 50/163

(52) U.S. Cl. CPC G06Q 40/062; G06Q 40/042; G06Q 50/163

(57) ABSTRACT

A fractionalized interest real-estate mortgage matching computer system and method. The computer system and method leverage algorithms and database management to streamline fractional investment mortgage matching processes and provides personalized facilitation to both borrowers and lenders. In embodiments, properties in property database may be identified as being suited for fractionalized interests or may have already been repurposed for fractionalized interests. The system and method may facilitate financing and acquisition of the property to be “reSpaced™” and ownership transfer of the property to a business entity is recorded. The system may facilitate filing with local building jurisdictions for permits to alter existing structures and construct new structures, apply for construction financing, receive building jurisdiction's requests for information and modifications, facilitate tax, rent and mortgage payments and automated recordation of ownership transfers.

### PRIORITY CLAIM

This application is a continuation-in-part (CIP) application and claims the benefit of U.S. Non-Provisional Application No. Ser. No. 18/646,029 entitled “SYSTEM AND METHOD FOR FACILITATING FRACTIONAL INVESTMENT IN REAL PROPERTY THROUGH MULTIPLE UNRELATED PARTIES” filed Apr. 25, 2024, which is incorporated by reference in its entirety herein for all purposes.

### BACKGROUND

The real-estate market often presents challenges for both buyers and sellers in finding suitable mortgage options that match buyers'buying power with real-estate for sale that is suited to said buyers'desires. Traditional mortgage lending offers a one-to-one basis for matching a buyer with a real-estate such that a buyer will acquire 100% of the interest in the desired real-estate. Such traditional mortgage arrangements rely on this one-to-one relationship and also rely heavily on manual processes, which can be time-consuming and inefficient. Moreover, The real-estate market often presents challenges for both buyers and sellers in finding suitable mortgage options that match buyers'buying power with real-estate for sale that is suited to said buyers'desires. Traditional mortgage lending offers a one-to-one basis for matching a buyer with a real-estate such that a buyer will acquire 100% of the interest in the desired real-estate. Such traditional mortgage arrangements rely on this one-to-one relationship and also rely heavily on manual processes, which can be time-consuming and inefficient. Moreover, the sheer volume of available mortgage products further complicates the process, making it difficult for individuals to identify the most suitable options for their specific needs. Additionally, the lack of personalized guidance in navigating these options can lead to suboptimal choices, resulting in financial strain for borrowers and missed opportunities for lenders and properties suited for multiple occupants to remain unacquired. Therefore, there is a clear need for a more efficient and personalized approach to mortgage matching in the real estate industry.

Further, several real-estate properties that are available in established traditional neighborhoods may comprise a significant number of rooms with substantial square footage. Such larger homes are often priced out of range for many buyers who may still desire to live in and acquire property in these established traditional neighborhoods. Thus, some properties may be well suited for tenants-in-common, but a lack of mortgage options prevents many people interested in such an arrangement from satisfying the requirements to acquire the more expensive property in the first place. Without any facilitation of mortgage options that allow for a many(buyers)-to-one(property) arrangement, these more expensive properties miss out on sales opportunities in most metropolitan markets.

### BRIEF DESCRIPTION OF THE DRAWINGS

Embodiments of the subject matter disclosed herein in accordance with the present disclosure will be described with reference to the drawings, in which:

FIG. 1 is a diagram of a fractional investment system according to an embodiment of the subject matter disclosed herein;

FIG. 2 is a diagram of computer network for facilitating computer communications in support of the fractional investment system according to an embodiment of the subject matter disclosed herein;

FIG. 3 is a flow chart of an algorithm for qualifying and assembling fractional investments in real estate according to an embodiment of the subject matter disclosed herein;

FIG. 4 is a flow chart of an algorithm for facilitating and delivering fractional investments in real estate according to an embodiment of the subject matter disclosed herein;

FIG. 5 is a flow chart of a method for divesting fractional investments according to an embodiment of the subject matter disclosed herein;

FIG. 6 is a diagram illustrating elements or components that may be present in a computer device or system configured to implement a method, process, function, or operation in accordance with an embodiment of the subject matter disclosed herein;

FIG. 7 is a diagram illustrating elements or components that may be present in a computer system configured to implement a fractional investment system for real estate property with automated recordation according to an embodiment of the subject matter disclosed herein; and FIG. 8 is a flow chart of a method for automated recordation for transactions involving the fractional investments according to an embodiment of the subject matter disclosed herein.

Note that the same numbers are used throughout the disclosure and figures to reference like components and features.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” as required by 35 U.S.C. § 112.

By way of an overview, aspects of the present disclosure address the shortcomings of existing mortgage matching methods by introducing a novel fractionalized interest real estate mortgage matching method. This computer system and method leverages algorithms and database management to streamline fractional investment mortgage matching processes and provides personalized facilitation to both borrowers and lenders. In embodiments, properties in property database may be identified as being suited for fractionalized interests or may have already been repurposed for fractionalized interests. The system and method may facilitate financing and acquisition of the property to be “reSpaced™” and ownership transfer of the property to a business entity is recorded.

The business, via the system facilitation, may work with surveyors, architects, designers, soils engineers, arborists, light planners, and the like, to determine how the existing home might be respaced or razed and rebuilt. The business, via the system facilitation, creates plans to increase density (add new residential structures) where allowed and execute financials to validate project economic viability. The system may facilitate filing with local building jurisdictions for permits to alter existing structures and construct new structures, apply for construction financing, and receive building jurisdiction's requests for information and modifications.

During a construction phase, the system may facilitate application for a Debt-Service Coverage Ratio (DSCR) loan based on anticipated monthly income of fractionalized residential structures once finished. After securing the DSCR loan, the system may facilitate application for a fractionalization overlay to the property to define ownership, occupancy rights, owner responsibilities, and the initial value of each Space. As such, each Space may represent a fractionalized interest in the property.

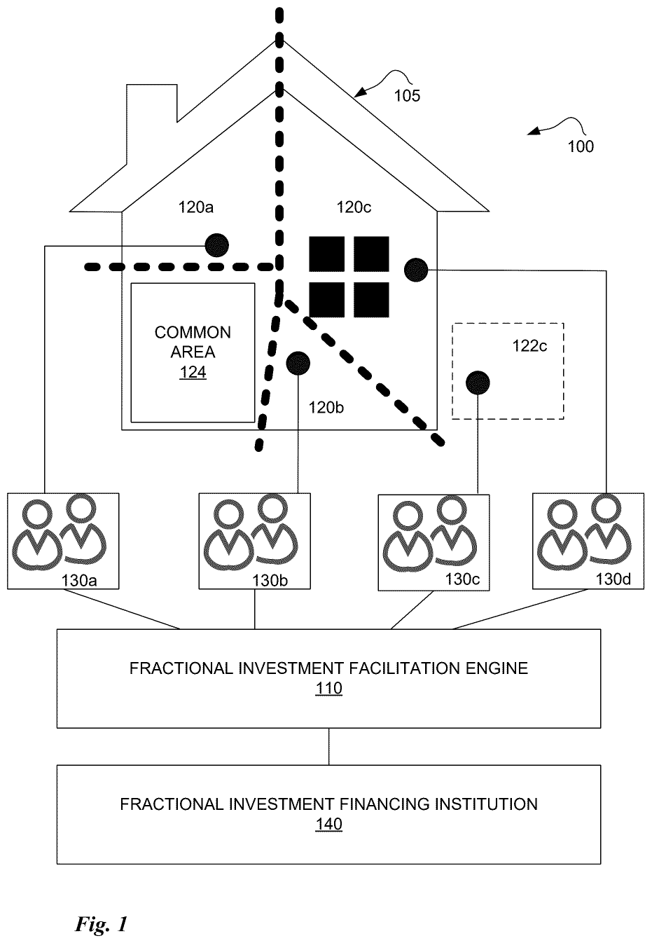

The system may facilitate a sale of each Space to owners who have exclusive right to occupy a private Space and shared right to occupy the shared spaces. This may create an ownership interest with no right to occupy the property. The system may facilitate creation of a mortgage underwriting system suited to intake all relevant financial and demographic information, analyze relevant financial and demographic information using an underwriting screening system. The system may further facilitate establishment of a fundability score which may be used to determine pass/fail fundability and risk premium (if any) to apply to a base mortgage interest rate, establish an online tax, rent, and mortgage payment mechanism. These and other novel features are better understood in conjunction with FIGS. 1-6 as discussed below.

FIG. 1 is a diagram of a fractional investment system 100 according to an embodiment of the subject matter disclosed herein. In this overview diagram, a specific property 105 may be a good candidate property 105 for fractional development and investment. That is, the specific property 105 may be well suited to have several compartmentalized partitions within the overall house. In this example, the candidate property includes a first fractional portion 120a, a second fractional portion 120b, a third fractional portion 120c and a common area 124. In this sense, each fractional portion 120a-c may be self-contained living space such that the partition may be secured away from other partitions. In other embodiments, these partitions are not secured away and ease of access throughout the partitions may remain similar to a traditional home. However, each fractional partition may be titled separately from each other such that different owners may secure different interests in each partition separately. Additionally, the common area 124 may be space co-owned by all fractional interest owners.

Once fractional portions 120a-c are established several distinct parties 130a-d may seek to acquire one or more of the fractional interests 120a-c in the fractional property 105. The fractional interests 120a-c comprise an ownership interest to occupy the respective interest. That is, the owner of the fractional interest 120a also enjoys a right of occupancy in the space defined in the fractional home 105 as fractional interest 120a, the owner of the fractional interest 120b also enjoys a right of occupancy in the space defined in the fractional home 105 as fractional interest 120b, and the owner of the fractional interest 120c also enjoys a right of occupancy in the space defined in the fractional home 105 as fractional interest 120c, Additionally, the fractional property 105 may also include one or more non-occupant fractional interests 122c. Such non-occupant fractional interests do not have a right to occupy any portion of the fractional home 105 and the position of the investor is for a fractional interest in the whole fractional property 105. The common area 124 includes rights of occupancy for all fractional owners that own a fractional interest 120a-c with the right of occupancy.

In one embodiment, fractional interest 120b (or any other fractional interest) may have an occupying right but in a space that is not a residential space. For example, fractional interest 120b may be a garage space or a storage space that is part of the overall fractional property 105, but is not deemed to be residential space under local ordinances (e.g., in order for a person or persons to legally reside in a space, some jurisdictions require a window and closet)

When the fractional property 105 is considered for sale to fractional interest parties, a fractional investment facilitation engine 110 may be employed to qualify and coordinate several parties, including, in this example, a first fractional owner 130a, a second fractional owner 130b, a third fractional owner 130c, and a fourth fractional owner 130d.

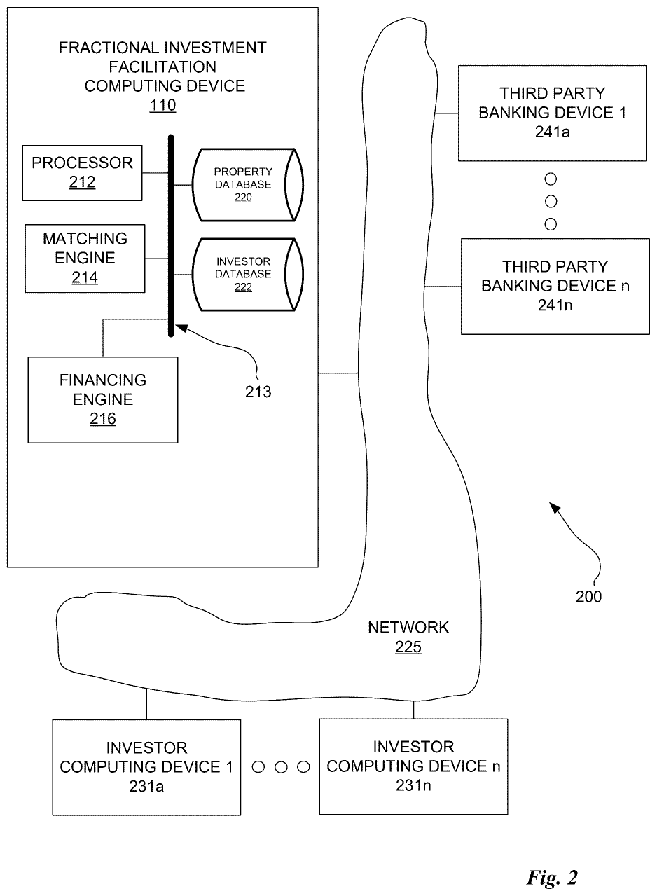

The fractional investment facilitation engine 110 may qualify each of these parties to attain financing from a fractional investment financing institution 140 so as so secure one or more respective fractional interests in the fractional property 105. Thus, once the overall fractional transaction is established and completed, the first fractional owner 130a may have an occupancy right to fractional interest 120a, a second fractional owner 130b may have an occupancy right to fractional interest 120b, a third fractional owner 130c may have an occupancy right to fractional interest 120c, and a fourth fractional owner 130d may have a non-occupancy right to fractional interest 122c. FIGS. 2-5 as described below detail additional steps for the various machinations of the aligning of these financial interests and the distribution of property rights in the fractional house 105.

FIG. 2 is a diagram of a computing environment 200 for facilitating computer communications in support of the fractional investment system according to an embodiment of the subject matter disclosed herein. The overall computing environment 200 may be generally comprised of three sets of computing devices that are all communicatively coupled to each other through a computing network 225, such as the Internet, though the network 225 may be a local Intranet or a virtual private network or the like. The three generalized categories of the coupled computers include a fractional investment facilitation server computer 110, one or more investor computing-devices 231a-231n, and one or more third-party computing devices 241a-241n and 242. Other data-collection and/or data provision services (such as MLS data collection services; neighborhood data collection services; crime data collection services, and the like) are contemplated as additional devices connected to the network 225 but not shown in this figure here for brevity. Collectively, these sets of computing devices may be used to receive and send data about fractional investors interested and securing fractional financing for fractional properties such as described above with respect to FIG. 1. The system may be implemented as a cloud-based service, software-as-a-service (Saas) platform, or via application programming interfaces (APIs) accessible over a network.

The fractional investment facilitation server computer 110 includes a processor 212 coupled to a computing bus 213 for interacting with different databases and computing engines. In this example, a matching engine 214 may be engaged to match interested fractional investors (typically cataloged in an investor database 222) with available fractional properties (typically logged in a property database 220). Furthermore, a financing engine 216 may facilitate underwriting once a set of interested fractional investors are interested in acquiring fractional interest in a fractional property. The facilitation of financing may be carried out in conjunction with one or more third party banking computer devices 241a-241n. Further yet, a recordation engine 217 may facilitate changes in government records at a government record computing device 242 when fractionalized interests are created, dissolved, or transferred as a result of a facilitated financial transaction handled by the financing engine 216.

The fractional investment facilitation server computer 110 may facilitate filing with local building jurisdictions for permits to alter existing structures and construct new structures, apply for construction financing, and receive building jurisdiction's requests for information and modifications. During a construction phase, the fractional investment facilitation server computer 110 may facilitate application for a Debt-Service Coverage Ratio (DSCR) loan based on anticipated monthly income of fractionalized residential structures once finished. After securing the DSCR loan, the fractional investment facilitation server computer 110 may facilitate application for a fractionalization overlay to the property to define ownership, occupancy rights, owner responsibilities, and the initial value of each Space. As such, each Space may represent a fractionalized interest in the property.

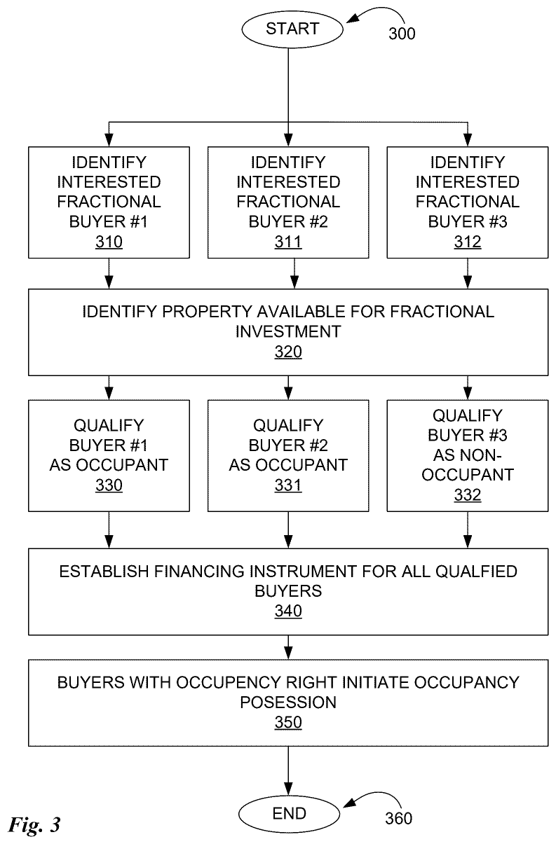

The fractional investment facilitation server computer 110 may facilitate a sale of each Space to owners who have exclusive right to occupy a private Space and shared right to occupy the shared spaces. This may create an ownership interest with no right to occupy the property. The fractional investment facilitation server computer 110 may facilitate creation of a mortgage underwriting system suited to intake all relevant financial and demographic information, analyze relevant financial and demographic information using an underwriting screening system. The fractional investment facilitation server computer 110 may further facilitate establishment of a fundability score which may be used to determine pass/fail fundability and risk premium (if any) to apply to a base mortgage interest rate, establish an online tax, rent, and mortgage payment mechanism. The fractional investment facilitation server computer 110 may track and maintain accessible, permanent records of payment histories for mortgage application fees, residential application fees, mortgage payment histories, fine payment histories, repair payment histories and the like. The fractional investment facilitation server computer 110 may also track and maintain accessible, permanent records of payment allocation to fees, interest, principal, taxes, insurance, fines, repairs and the like. It can facilitate payment of property taxes to local taxing authorities and insurance premiums to insurers and provide deeds of trust and/or mortgages to fractional owners. It can generate deed of trust and/or mortgage documents, and provide permanent storage thereof, of signed and (when applicable) notarized deeds of trust and/or mortgage documents. The fractional investment facilitation server computer 110 may file electronically stored deeds of trust and/or mortgage documents with municipal recording authorities and store recording numbers associated with said recorded documents. The fractional investment facilitation server computer 110 may make such web-based mortgage underwriting and processing system available for public FSBO sales and owner-financed sales. Together, these components may accomplish the algorithms discussed below with respect to FIG. 3-5. Further, Operations described herein may be executed synchronously, asynchronously, or in an event-driven manner, and steps may be performed in parallel or in a different order without departing from the scope of the disclosure.

FIG. 3 is a flow chart of an algorithm 300 for qualifying and assembling fractional investments in real estate according to an embodiment of the subject matter disclosed herein. In this algorithm, a plurality of investors may wish to invest in a fractional property such that each individual investor may be individually qualified to participate and then the group of inventors may be qualified collectively. Thus, after the algorithm 300 starts, individual investors may be initially identified as possible participants in a fractional investment. In this example embodiment, a first fractional buyer is identified at step 310, a second fractional buyer is identified at step 311, and third fractional buyer is identified at step 312.

In some embodiments, these potential fractional buyers may be identified and involved using a number of different methods and steps (not detailed in FIG. 3). In a first manner, fractional properties may be listed for sale on the Multiple-Listing Service (MLS) and receiving inquiries by any means of communication including face-to-face at open houses. In a second manner, advertising on a website for a fractional owner listing representative or on third-party websites such as Zillow.com™, Redfin.com™ FSBO.com™, and the like may assist in facilitating inquiries by any means of communication including face-to-face at an open houses. In a third manner, a listing representative may build a referral network of real estate brokers, mortgage brokers, bankers, attorneys and financial advisors among others who receive compensation for referring a potential ReSpace™ buyer.

After identification, potential buyers may also be authenticated and qualified using similar steps and methods (also not shown in detail in FIG. 3). Such qualifying criteria used may include relevant financial information such as employment history, salary, credit score, and other financial reliability measures. Additional qualifying criteria used may include relevant demographic information such criminal history (where allowed by law), personal references and other related demographic information.

The algorithm 300 may identify fractional properties suited for this set of fractional buyers at step 320. This may be accomplished using a fractional investor and property matching engine 214 that is part of the fractional investment facilitation system 110 of FIG. 2. Specific criteria that may influence the matching engine includes, in any combination or variability weighting, the following:
space size;
number of spaces in the home;
size of home;
style of home;
occupants of the other Spaces;
property amenities;
geographical preferences including but not limited to state, city, neighborhood;
desired proximity to employment centers or a particular employer;
desired proximity to transit;
desired proximity to schools;
desired proximity to community amenities such as libraries and senior centers;
desired proximity to shopping;
desired proximity to community amenities such as bookstores, grocery stores, coffee shops, bars and restaurants;
desired proximity to parks and recreational areas;
desired proximity to churches of a particular denomination;
desired neighborhood walkability score;
desired neighborhood crime score; and
desired neighborhood bike score.
   As the algorithm 300 continues, individual investors that have agreed to pursue acquisition of fractional ownership of a matched property may then be individually and collectively qualified as participants in a fractional investment. In this example embodiment, a first fractional buyer is qualified at step 330, a second fractional buyer is qualified at step 331, and third fractional buyer is qualified at step 332. As briefly detailed above, specific criteria for qualifying potential fractional buyers may include but are not limited to relevant financial information such as employment history, salary, credit score, and other financial reliability measures. Additionally, qualifying potential fractional buyers may include but are not limited to relevant demographic information such as criminal history (where allowed by law), residential stability (where allowed by law), personal references, and other relevant demographic data.

Once all buyers are qualified, a proper financial instrument may be established at step 340 such that each qualified buyer acquires a respective financial interest. Each acquired fractional interest may enjoy a right of occupancy in one or fractional portions of the acquired property while some fractional interest may have no right to occupy. Fractional owners with respective rights to occupy may then initiate occupying the fractional property at step 350. This algorithm 300 ends at step 360. The algorithm of FIG. 3 may repeat when any owner or combination of owners elects to sell any respective fractional interest, and said sellers, in turns may identify interested fractional buyers by hiring a broker or advertising the interest for sale in any number of public media such as FSBO.com.

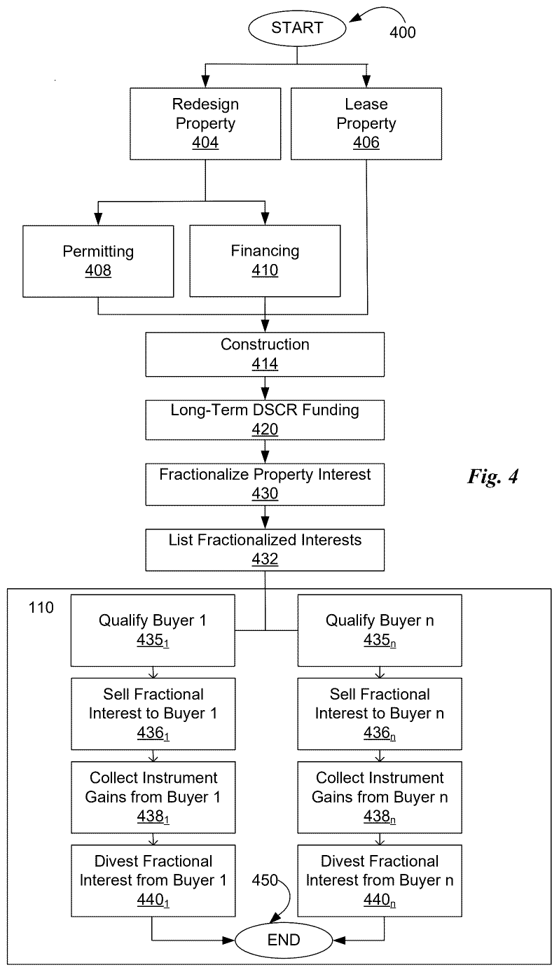

FIG. 4 is a flow chart of an algorithm 400 for facilitating and delivering fractional investments in real estate according to an embodiment of the subject matter disclosed herein. In FIG. 4, an additional algorithm 400 is presented for facilitating moving a typical single-owner property into a fractional ownership role with the overall system disclosed herein. The initial steps in this algorithm detail taking a property to position ready for fractional investment.

To begin, a specific property may be identified as suitable for fractional ownership and then moved into a redesign phase 404. During redesign, the property may be leased 406 separately while, at step 404, the property is evaluated by surveyors, architects, designers, engineers, soils experts, arborists, and other professionals as may be required by the local permitting authority. Decisions are made as to whether to remodel the existing home or to demolish and build a new structure. In addition, the team determines whether additional structures may be built on the property. The team evaluates the economic viability of each option. At the conclusion of step 404 (Design and Economic Feasibility), step 408 (Permitting) and step 410 (Financing) begin simultaneously.

In step 408, the design package is submitted to the local permitting authority, initiating what may be several rounds of review and revision of plans and specs. Each review round results in reactivation of one or more of the participants in step 404 for plan revision as required and for renewed economic analysis. A revision loop between step 404 and 408 terminates when the local permitting authority authorizes permits, the permit fees are paid, and the permits are issued.

In step 410, the permit application, plans, construction budget, materials list, builder's resume and developer's financial statements are submitted to multiple construction lenders for construction financing. Step 410 terminates when a lender agrees to supply funding on terms that are acceptable to the developer. When permits have been issued in step 408 and construction funding is in place in step 410, and after the end of any lease 406, construction may begin to transition the property into distinct occupiable partitions suited for fractional ownership in step 414.

When step 414 concludes, the property may be subject to aligning with Long-term Debt-Service Coverage Ratio (DSCR) Funding 420 so as to prepare the partitions for fractional investment. This funding may bear a term of 10-years, 12-years, 15-years, 25-years, 30-years or longer.

Once long-term DSCR funding is institutionalized, the property may be partitioned into salable fractional interests at step 430. The fractionalization overlay defines ownership, occupancy rights, owner responsibilities and the initial value of each fractional share. At the conclusion of step 430, the individual fractional shares are offered for public sale as shown in step 432 or added to the property database 220 of FIG. 2.

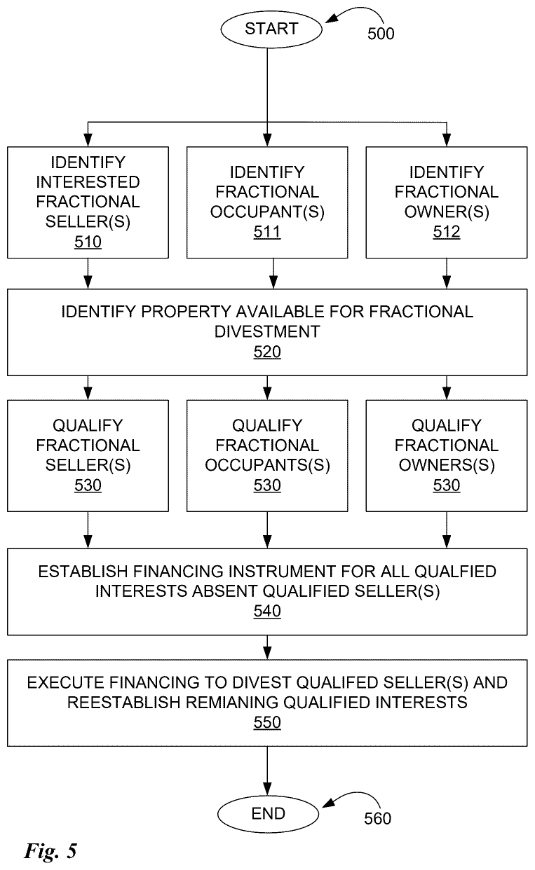

Then the fractional investment engine 110 can manage any further transaction once the fractional property is ready for fractional investments. This includes qualifying buyers 435₁-435ₙ, funding fractional investments for transaction 436₁-436ₙ, collecting financial instrument gains 4381-438n, and divesting fractional interests 440₁-440ₙ. These steps are detailed further with respect to FIG. 3 for investment and FIG. 5 for divestment. The algorithm 400 ends at step 450.

FIG. 5 is a flow chart of an algorithm 500 for divesting fractional investments according to an embodiment of the subject matter disclosed herein. In this algorithm, one or more of a plurality of investors that are fractional owners of a fractional property may wish to divest from the fractional property. When such a divestment is sought, the algorithm 500 seeks to identify those who are already participants in this fractional investment. In this example embodiment, a first group comprises fractional owners wishing to sell their respective interests identified at step 510, a second group comprising fractional owners remaining as fractional owners with an occupation right is identified at step 511, and third group of fractional owners with no occupation right is identified at step 512. Identification steps for potential sellers may be similar to that which has been previously described with respect to FIGS. 3 and 4.

The algorithm 500 may identify the fractional properties suited for this divestment at step 520. Identification steps for potential divestment fractional interests may be similar to that which has been previously described with respect to FIGS. 3 and 4.

As the algorithm 500 continues, individual investors that have agreed to remain in fractional ownership of the fractional property may then be individually and collectively qualified as participants in a new fractional investment that is devoid of the selling party interests. In this example embodiment, a fractional seller is qualified at step 530, a fractional owner-occupant is qualified at step 531, and fractional owner without occupancy is qualified at step 532.

Once all remaining interests are qualified, a proper financial instrument may be established at step 540 such that each qualified remaining interest acquires or distributes respective financial interests in the fractional property. Each acquired fractional interest may enjoy a right of occupancy in one or fractional portions of the acquired property while some fractional interest may have no right to occupy. Fractional owners with respective rights to occupy may then continue occupying the fractional property and qualified sellers are divested with a return of value of the current fractional interest at step 550. This algorithm 500 ends at step 560.

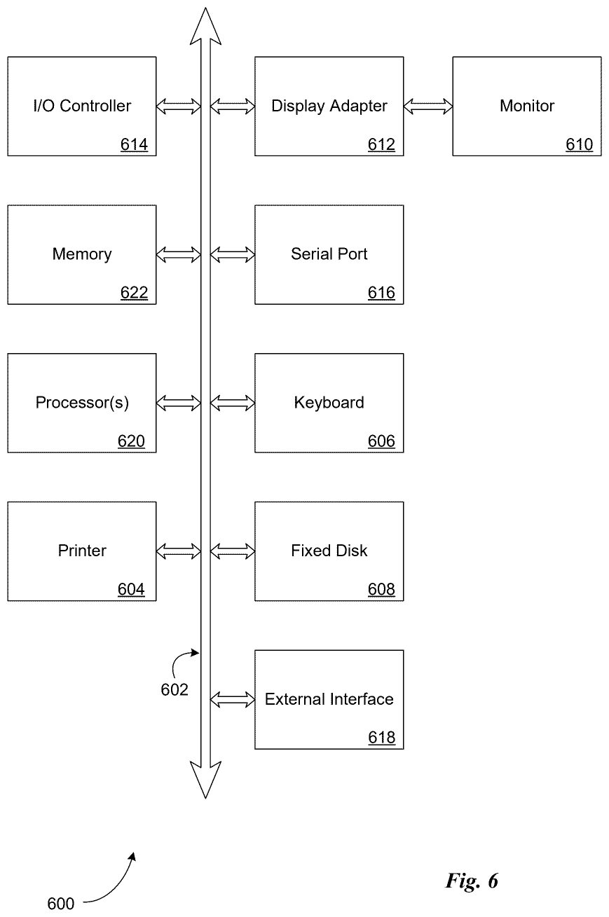

FIG. 6 is a diagram illustrating elements or components that may be present in a computer device or system configured to implement a method, process, function, or operation in accordance with an embodiment. In accordance with one or more embodiments, the system, apparatus, methods, processes, functions, and/or operations for enabling efficient configuration and presentation of a fractional investment matching and financing system that may be wholly or partially implemented in the form of a set of instructions executed by one or more programmed computer processors such as a master control unit (MCU), central processing unit (CPU), or microprocessor. Such processors may be incorporated in an apparatus, server, client or other computing or data processing device operated by, or in communication with, other components of the system. As an example, FIG. 6 is a diagram illustrating elements or components that may be present in a computer device or system 600 configured to implement a method, process, function, or operation in accordance with an embodiment. The subsystems shown in FIG. 6 are interconnected via a system bus 602. Additional subsystems include a printer 604, a keyboard 606, a fixed disk 608, and a monitor 610, which is coupled to a display adapter 612. Peripherals and input/output (I/O) devices, which couple to an I/O controller 614, can be connected to the computer system by any number of means known in the art, such as a serial port 616. For example, the serial port 616 or an external interface 618 can be utilized to connect the computer device 600 to further devices and/or systems not shown in FIG. 6 including a wide area network such as the Internet, a mouse input device, and/or a scanner. The interconnection via the system bus 602 allows one or more processors 620 to communicate with each subsystem and to control the execution of instructions that may be stored in a system memory 622 and/or the fixed disk 608, as well as the exchange of information between subsystems. The system memory 622 and/or the fixed disk 608 may embody a tangible computer-readable medium.

The subject matter described herein can be implemented in software in combination with hardware and/or firmware. For example, the subject matter described herein may be implemented in software executed by one or more processors. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

The system may use a bus that can be any of several types of suitable bus structure(s) including the memory bus or memory controller, a peripheral bus or external bus, and/or a local bus using any suitable variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The systems and methods herein enable rapid ingestion of big data sets in a distributed computing environment. The metadata driven approach intake processing reduces source ingestion time, enhances reliability, and automates data intake. Furthermore, the platform agnostic nature of the present disclosure can operate on an input source in any electronic format. The error logging and reporting of the present disclosure further enable users to monitor progress and identify bad data based on predetermined or dynamically generated validation tolerances.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

The terms “computer program medium” and “computer usable medium” and “computer readable medium” are used to generally refer to media such as removable storage drive and a hard disk installed in hard disk drive. These computer program products provide software to computer system. Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method are described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of process flow and the descriptions thereof may make reference to user WINDOWS®, webpages, websites, web forms, prompts, and the like. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity. The described user interfaces and workflows may be implemented on any operating system, including but not limited to WINDOWS®, macOS®, Linux®, Unix®, iOS®, Android®, or web-based environments.

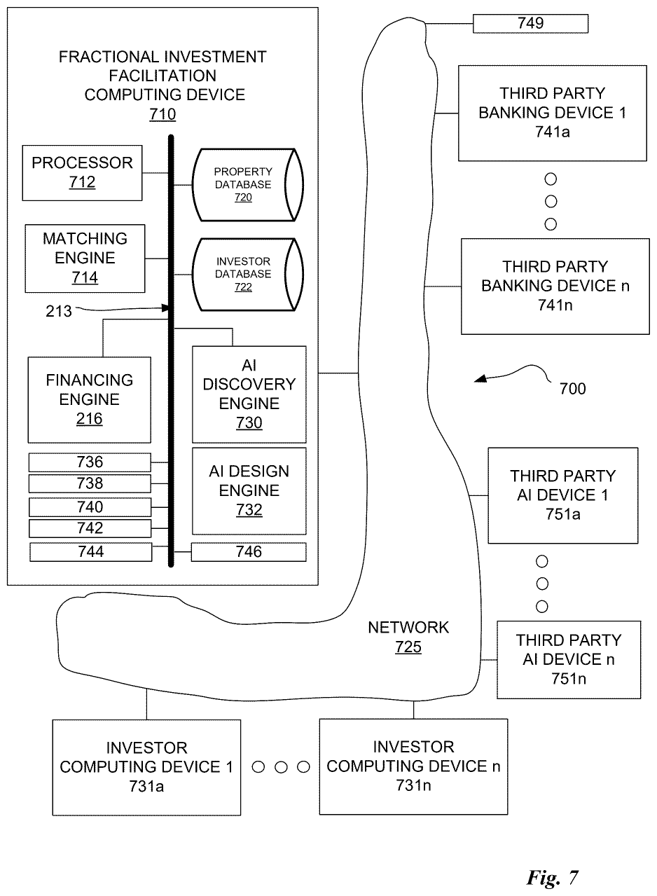

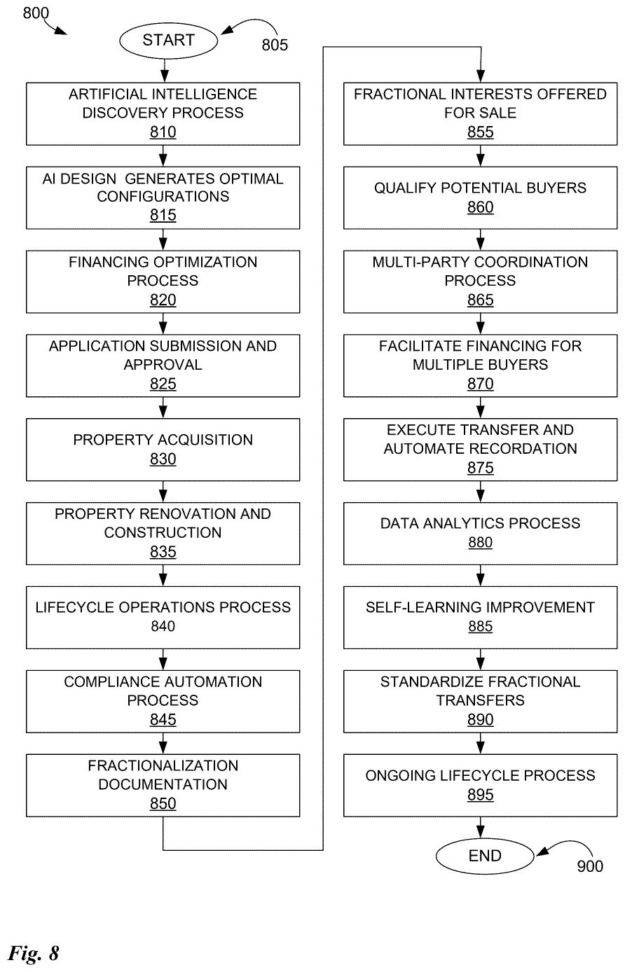

FIG. 7 is a diagram illustrating elements or components that may be present in a computer system configured to implement a fractional investment system for real estate property with automated recordation and operational intelligence according to an embodiment of the subject matter disclosed herein. The system 700 may include components similar to those described with respect to FIG. 2, with additional elements to support enhanced operational capabilities. The system 700 may include a fractional investment facilitation server computer 710 that may be communicatively coupled to a computing network 725. The fractional investment facilitation server computer 710 may include a processor 712 coupled to a computing bus 713. The processor 712 may interact with various databases and computing engines to facilitate fractional investment operations.

The fractional investment facilitation server computer 710 may include an investor database 722 for storing information about potential and qualified fractional investors. A property database 720 may store information about properties available for fractionalization or properties that have already been fractionalized. A matching engine 714 may be configured to match qualified fractional investors with available fractional properties based on various criteria. A financing engine 716 may facilitate underwriting and financial transactions for fractional investments. A recordation engine 717 may facilitate the recording of ownership changes and property interest transfers with government entities.

The system 700 may further include an artificial intelligence discovery engine 730 coupled to the computing bus 713. The artificial intelligence discovery engine 730 may be configured to analyze property data to identify properties suitable for fractionalization. The artificial intelligence discovery engine 730 may evaluate factors such as property location, size, configuration, zoning regulations, and market conditions. The artificial intelligence discovery engine 730 may generate recommendations for properties that may be candidates for fractional development. The artificial intelligence discovery engine 730 may continuously learn from historical transaction data and market trends to improve property identification accuracy.

An artificial intelligence design engine 732 may be coupled to the computing bus 713. The artificial intelligence design engine 732 may be configured to generate optimal fractionalization configurations for identified properties. The artificial intelligence design engine 732 may analyze property layouts and determine how spaces may be partitioned to maximize value and occupancy potential. The artificial intelligence design engine 732 may consider factors such as building codes, accessibility requirements, and market preferences for space configurations. The artificial intelligence design engine 732 may generate preliminary design specifications that may be provided to architects and designers for detailed development.

A financing optimization engine 734 may be coupled to the computing bus 713. The financing optimization engine 734 may be configured to analyze various financing options for fractional property development and acquisition. The financing optimization engine 734 may evaluate construction financing terms, long-term debt options, and fractional buyer financing structures. The financing optimization engine 734 may generate recommendations for optimal financing structures that may minimize costs and maximize returns. The financing optimization engine 734 may continuously monitor market conditions and adjust financing recommendations based on changing interest rates and lending criteria.

A lifecycle operations engine 736 may be coupled to the computing bus 713. The lifecycle operations engine 736 may be configured to manage ongoing operations of fractionalized properties throughout their operational lifetime. The lifecycle operations engine 736 may track maintenance schedules, repair needs, and property condition assessments. The lifecycle operations engine 736 may coordinate with service providers for routine maintenance and emergency repairs. The lifecycle operations engine 736 may generate alerts when maintenance activities may be required or when property conditions may require attention.

A compliance automation engine 738 may be coupled to the computing bus 713. The compliance automation engine 738 may be configured to monitor and enforce compliance with applicable regulations and contractual obligations. The compliance automation engine 738 may track local zoning requirements, building codes, and occupancy regulations. The compliance automation engine 738 may monitor fractional ownership agreements to ensure that all parties may be adhering to their obligations. The compliance automation engine 738 may generate compliance reports and alerts when potential violations may be detected. The compliance automation engine 738 may automatically update compliance requirements as regulations may change.

A multi-party coordination engine 740 may be coupled to the computing bus 713. The multi-party coordination engine 740 may be configured to facilitate interactions among multiple fractional owners of a property. The multi-party coordination engine 740 may manage communication channels between fractional owners. The multi-party coordination engine 740 may coordinate decision-making processes for shared property matters. The multi-party coordination engine 740 may track voting on property-related decisions and maintain records of owner agreements. The multi-party coordination engine 740 may resolve conflicts that may arise between fractional owners through automated mediation protocols.

A data analytics engine 742 may be coupled to the computing bus 713. The data analytics engine 742 may be configured to analyze data related to fractional property ownership and operations. The data analytics engine 742 may track co-ownership behavior patterns and identify trends in owner interactions. The data analytics engine 742 may analyze community dynamics within fractionalized properties to assess satisfaction levels and potential issues. The data analytics engine 742 may evaluate financial performance metrics for individual fractional interests and entire properties. The data analytics engine 742 may generate predictive models for property value appreciation and investment returns.

A platform execution engine 744 may be coupled to the computing bus 713. The platform execution engine 744 may be configured to provide a standardized framework for fractional property transactions. The platform execution engine 744 may implement repeatable processes for property identification, development, and sale. The platform execution engine 744 may maintain templates for legal documents, financial instruments, and operational agreements. The platform execution engine 744 may ensure consistency across multiple fractional property projects. The platform execution engine 744 may scale operations to handle increasing numbers of properties and transactions.

A self-learning system engine 746 may be coupled to the computing bus 713. The self-learning system engine 746 may be configured to continuously improve system performance based on accumulated data and outcomes. The self-learning system engine 746 may analyze successful and unsuccessful transactions to identify factors that may influence outcomes. The self-learning system engine 746 may adjust matching algorithms based on observed compatibility between fractional owners. The self-learning system engine 746 may refine property valuation models based on actual sale prices and market performance. The self-learning system engine 746 may update underwriting criteria based on payment performance and default rates.

The fractional investment facilitation server computer 710 may be communicatively coupled to one or more investor computing devices 731a-731n through the computing network 725. The investor computing devices 731a-731n may be operated by potential or current fractional property investors. The investor computing devices 731a-731n may provide interfaces for investors to view available properties, submit applications, and manage their fractional interests. The investor computing devices 731a-731n may receive notifications and updates regarding properties of interest or owned properties.

The fractional investment facilitation server computer 710 may be communicatively coupled to one or more third-party computing devices 741a-741n through the computing network 725. The third-party computing devices 741a-741n may be operated by financial institutions, construction companies, design professionals, or other service providers. The third-party computing devices 741a-741n may exchange data with the fractional investment facilitation server computer 710 to facilitate various aspects of fractional property development and management.

The fractional investment facilitation server computer 710 may be communicatively coupled to one or more third-party Al devices 751a-751n (e.g., machine-learning devices utilizing machine-learning techniques) through the computing network 725. The third-party Al devices 751a-751n may be operated by third-party Al companies, or other service providers. The third-party Al devices 751a-751n may exchange data with the fractional investment facilitation server computer 710 to facilitate various aspects of Al functionality within the fractional investment facilitation server computer 710. In some embodiments, outputs generated by artificial intelligence engines may be reviewed, approved, modified, or overridden by a human operator.

A government recordation computing device 749 may be communicatively coupled to the fractional investment facilitation server computer 710 through the computing network 725. The government recordation computing device 749 may be operated by governmental entities responsible for maintaining property ownership records. The recordation engine 717 may communicate with the government recordation computing device 749 to file ownership changes and retrieve recorded documents. Regulatory and recordation processes described herein may be adapted to comply with jurisdiction-specific legal, financial, and governmental requirements.

A number of additional databases may be populated, updated and maintained at the fractional investment facilitation server computer 710 n a first example, the system 700 may include a behavioral tracking database coupled to the computing bus 713. The behavioral tracking database may store data regarding fractional owner behaviors, including payment histories, property usage patterns, and interaction patterns with other owners. The behavioral tracking database may be accessed by the data analytics engine 742 to generate insights into owner behavior and property performance. Data storage, transmission, and processing may incorporate encryption, access controls, audit logging, and privacy-preserving techniques.

In a second example, the system 700 may include a community dynamics database may be coupled to the computing bus 713. The community dynamics database may store information about interactions among fractional owners within individual properties. The community dynamics database may track communication frequency, conflict incidents, collaborative activities, and satisfaction surveys. The community dynamics database may be analyzed by the data analytics engine 742 to assess the health of fractional ownership communities. Data storage, transmission, and processing may incorporate encryption, access controls, audit logging, and privacy-preserving techniques.

A financial performance database may be coupled to the computing bus 713. The financial performance database may store financial data for fractional properties and individual fractional interests. The financial performance database may track property values, rental income, expense allocations, and return on investment metrics. The financial performance database may be accessed by the financing optimization engine 734 and the data analytics engine 742 to evaluate investment performance. Data storage, transmission, and processing may incorporate encryption, access controls, audit logging, and privacy-preserving techniques.

The artificial intelligence discovery engine 730 may communicate with external data sources through the computing network 725 to obtain market data, property listings, and demographic information. The artificial intelligence discovery engine 730 may apply machine learning algorithms to identify patterns that may indicate properties suitable for fractionalization. The artificial intelligence discovery engine 730 may generate a prioritized list of candidate properties that may be stored in the property database 720. Machine learning algorithms may include, without limitation, supervised, unsupervised, semi-supervised, reinforcement learning, neural networks, statistical learning models, or other adaptive or learned models.

The artificial intelligence design engine 732 may receive property data from the property database 720 and generate multiple fractionalization scenarios for each property. The artificial intelligence design engine 732 may evaluate each scenario based on projected costs, potential revenues, and market demand. The artificial intelligence design engine 732 may select an optimal fractionalization configuration that may maximize economic viability. The artificial intelligence design engine 732 may generate design specifications that may be provided to architects and engineers for detailed planning.

The financing optimization engine 734 may analyze financing options from multiple lenders accessed through the third-party computing devices 741a-741n. The financing optimization engine 734 may compare interest rates, terms, fees, and conditions for various financing products. The financing optimization engine 734 may calculate total costs and projected returns for different financing structures. The financing optimization engine 734 may recommend a financing approach that may optimize financial outcomes for the fractional property development.

The lifecycle operations engine 736 may maintain a schedule of maintenance activities for each fractionalized property. The lifecycle operations engine 736 may generate work orders for routine maintenance tasks. The lifecycle operations engine 736 may coordinate with service providers to schedule and complete maintenance activities. The lifecycle operations engine 736 may track maintenance costs and allocate expenses among fractional owners according to ownership agreements. The lifecycle operations engine 736 may maintain a history of all maintenance and repair activities for each property.

The compliance automation engine 738 may monitor regulatory requirements applicable to each fractionalized property. The compliance automation engine 738 may track permit expiration dates and initiate renewal processes. The compliance automation engine 738 may verify that property modifications may comply with applicable building codes. The compliance automation engine 738 may ensure that occupancy levels may not exceed permitted limits. The compliance automation engine 738 may generate compliance reports for regulatory authorities and property owners.

The multi-party coordination engine 740 may provide communication tools for fractional owners to interact with each other. The multi-party coordination engine 740 may facilitate voting on property-related decisions such as major repairs or modifications. The multi-party coordination engine 740 may track voting results and implement approved decisions. The multi-party coordination engine 740 may mediate disputes between fractional owners through structured resolution processes. The multi-party coordination engine 740 may maintain records of all owner communications and decisions.

The data analytics engine 742 may generate reports on property performance, owner satisfaction, and investment returns. The data analytics engine 742 may identify trends in fractional property markets and predict future performance. The data analytics engine 742 may provide insights to inform property acquisition and development decisions. The data analytics engine 742 may benchmark individual properties against comparable properties to assess relative performance. The data analytics engine 742 may generate customized reports for individual fractional owners showing their investment performance.

The platform execution engine 744 may provide standardized workflows for all stages of fractional property development and management. The platform execution engine 744 may ensure that each property may follow consistent processes from identification through ongoing operations. The platform execution engine 744 may reduce transaction costs through standardization and automation. The platform execution engine 744 may enable rapid scaling of fractional property operations across multiple properties and markets. The system may be configured for multi-tenant or white-label deployment, enabling multiple independent entities to operate fractional investment platforms using shared infrastructure.

The self-learning system engine 746 may continuously analyze outcomes of fractional property transactions and operations. The self-learning system engine 746 may identify factors that may correlate with successful outcomes. The self-learning system engine 746 may adjust system parameters and algorithms to improve future performance. The self-learning system engine 746 may incorporate new data sources and analytical techniques as they may become available. The self-learning system engine 746 may evolve the system capabilities over time to adapt to changing market conditions and user needs.

The system 700 may provide an integrated platform for managing all aspects of fractional property investment from initial property identification through ongoing operations. The system 700 may reduce friction in fractional property transactions through automation and standardization. The system 700 may enable scalable fractional property operations that may be replicated across multiple properties and markets. The system may be configured for multi-tenant or white-label deployment, enabling multiple independent entities to operate fractional investment platforms using shared infrastructure. The system 700 may enhance value creation through data-driven insights and continuous improvement of system capabilities.

FIG. 8 is a flow chart of a method 800 for automated recordation for transactions involving the fractional investments according to an embodiment of the subject matter disclosed herein. The method 800 may be implemented using a system 700 of FIG. 7, with additional components and capabilities to enable enhanced operational intelligence and automation. The method 800 may begin at step 805.

At step 810, an artificial intelligence discovery process may be executed to identify properties suitable for fractionalization. The artificial intelligence discovery process may analyze property data from multiple sources. The artificial intelligence discovery process may evaluate property characteristics including location, size, configuration, and zoning. The artificial intelligence discovery process may assess market conditions in the geographic area of each property. The artificial intelligence discovery process may apply machine learning algorithms to identify patterns associated with successful fractional properties. The artificial intelligence discovery process may generate a ranked list of candidate properties based on predicted suitability for fractionalization. Property data for identified candidate properties may be stored in a property database. The property data may include property addresses, parcel numbers, current ownership information, and physical characteristics. The property data may include zoning classifications and permitted uses. The property data may include market value estimates and comparable property data. The property data may be updated periodically to reflect changes in property status or market conditions.

At step 815, an artificial intelligence design process may be executed to generate optimal fractionalization configurations for candidate properties. The artificial intelligence design process may analyze property layouts and structural characteristics. The artificial intelligence design process may evaluate multiple potential configurations for dividing the property into fractional interests. The artificial intelligence design process may consider building codes, accessibility requirements, and safety regulations. The artificial intelligence design process may assess market demand for different space configurations. The artificial intelligence design process may calculate projected costs for implementing each configuration. The artificial intelligence design process may select a configuration that may maximize economic viability.

At step 820, a financing optimization process may be executed to identify optimal financing structures. The financing optimization process may analyze available financing options from multiple lenders. The financing optimization process may evaluate construction financing terms including interest rates, fees, and repayment schedules. The financing optimization process may evaluate long-term debt options for permanent financing. The financing optimization process may calculate total financing costs for different financing structures. The financing optimization process may project returns on investment for different financing approaches. The financing optimization process may select a financing structure that may minimize costs and maximize returns.

At step 825, financing applications may be submitted to selected lenders. The financing applications may include property information, design specifications, and construction budgets. The financing applications may include financial statements and credit information for the property developer. The financing applications may be submitted electronically through network connections to lender computing system. financing approval may be received from one or more lenders. The financing approval may specify loan amounts, interest rates, fees, and repayment terms. The financing approval may include conditions that may need to be satisfied before funding may be disbursed. The financing approval information may be stored in a financing database.

At step 830, property acquisition may be facilitated using approved financing. A purchase agreement may be executed between the property developer and the current property owner. Funds from the approved financing may be transferred to complete the property purchase. Ownership of the property may be transferred to the property developer. The ownership transfer may be recorded with governmental recording authorities.

At step 835, construction or renovation may be initiated to implement the fractionalization configuration. Construction contracts may be executed with construction companies. Construction activities may be monitored to ensure compliance with design specifications. Construction progress may be tracked and reported to lenders and other stakeholders. Construction costs may be tracked and compared to budgeted amounts.

At step 840, a lifecycle operations process may be initiated to manage ongoing property operations. The lifecycle operations process may establish maintenance schedules for the property. The lifecycle operations process may coordinate with service providers for routine maintenance activities. The lifecycle operations process may track property condition and identify repair needs. The lifecycle operations process may generate work orders for maintenance and repair activities. The lifecycle operations process may allocate maintenance costs among fractional owners.

At step 845, a compliance automation process may be executed to ensure regulatory compliance. The compliance automation process may monitor applicable zoning regulations, building codes, and occupancy requirements. The compliance automation process may track permit requirements and expiration dates. The compliance automation process may initiate permit renewal processes before permits may expire. The compliance automation process may verify that property modifications may comply with applicable regulations. The compliance automation process may generate compliance reports for regulatory authorities.

At step 850, fractionalization documentation may be prepared to define fractional ownership interests. The fractionalization documentation may specify the boundaries of each fractional space. The fractionalization documentation may define occupancy rights for each fractional interest. The fractionalization documentation may specify owner responsibilities for maintenance and expenses. The fractionalization documentation may establish initial values for each fractional interest. The fractionalization documentation may be recorded with governmental recording authorities.

At step 855, fractional interests may be offered for sale to potential buyers. Marketing materials may be prepared describing the property and available fractional interests. The property may be listed on multiple listing services and real estate websites. Open houses may be conducted to allow potential buyers to view the property. Inquiries from potential buyers may be received and processed.

At step 860, potential fractional buyers may be qualified using underwriting criteria. Financial information may be collected from potential buyers including employment history, income, and credit scores. Demographic information may be collected including residential history and references. The collected information may be analyzed to determine whether each potential buyer may meet qualification criteria. A fundability score may be calculated for each potential buyer. Potential buyers who may meet qualification criteria may be approved for financing. A matching process may be executed to align qualified buyers with available fractional interests. Buyer preferences may be compared to characteristics of available fractional interests. Compatibility between potential co-owners may be assessed. Optimal matches between buyers and fractional interests may be identified. Matched buyers may be notified of available fractional interests that may meet their preferences.

At step 865, a multi-party coordination process may be executed to facilitate interactions among multiple fractional buyers. Communication channels may be established to allow potential co-owners to interact. Information about the property and fractional ownership structure may be provided to all potential buyers. Questions and concerns from potential buyers may be addressed. Agreement among all fractional buyers may be confirmed before proceeding with the transaction.

At step 870, financing for fractional buyers may be facilitated. Mortgage applications may be submitted on behalf of qualified fractional buyers. Underwriting may be completed for each fractional buyer. Mortgage approvals may be obtained for each fractional buyer. Closing documents may be prepared for each fractional interest purchase.

At step 875, ownership transfers may be completed for each fractional interest. Purchase agreements may be executed between the property developer and each fractional buyer. Funds from buyer mortgages may be transferred to complete the purchases. Ownership of each fractional interest may be transferred to the respective buyer. The ownership transfers may be recorded with governmental recording authorities.

At step 880, a data analytics process may be executed to track and analyze fractional ownership data. Behavioral data may be collected regarding fractional owner activities. Payment histories may be tracked for each fractional owner. Property usage patterns may be monitored. Interactions among fractional owners may be tracked. The collected data may be analyzed to identify patterns and trends. Community dynamics within the fractionalized property may be assessed. Financial performance metrics may be calculated for the property and individual fractional interests.

At step 885, a self-learning process may be executed to improve system performance. Transaction outcomes may be analyzed to identify factors associated with successful transactions. Owner satisfaction data may be analyzed to identify factors associated with positive ownership experiences. Property performance data may be analyzed to identify factors associated with strong financial returns. System algorithms and parameters may be adjusted based on the analysis results. Underwriting criteria may be refined based on observed payment performance. Matching algorithms may be adjusted based on observed compatibility among co-owners. Property valuation models may be updated based on actual sale prices and market performance.

At step 890, a platform execution process may be implemented to standardize fractional property operations. Standardized workflows may be established for property identification, development, and sale. Document templates may be created for legal agreements, financial instruments, and operational procedures. Process automation may be implemented to reduce manual effort and transaction costs. Quality control procedures may be established to ensure consistency across multiple properties. The standardized platform may enable scalable operations across multiple properties and markets.

At step 895, ongoing lifecycle operations may continue for the fractionalized property. Routine maintenance activities may be performed according to established schedules. Property condition may be monitored continuously. Repair needs may be identified and addressed promptly. Owner communications may be facilitated through established channels. Financial transactions may be processed including mortgage payments, tax payments, and expense allocations. Compliance monitoring may continue to ensure ongoing regulatory compliance.

Additional method steps may include embedded logic may be applied to automate decision-making processes. Rules-based logic may be implemented to handle routine decisions automatically. Exception conditions may be identified and escalated for human review. Approval workflows may be automated for standard transactions. Notification triggers may be established to alert stakeholders of important events. The embedded logic may reduce manual intervention requirements and accelerate transaction processing.

Another additional step may include friction point removal may be implemented to streamline multi-party ownership operations. Common sources of conflict among fractional owners may be identified. Automated resolution mechanisms may be implemented for routine disputes. Clear policies and procedures may be established for shared decision-making. Communication tools may be provided to facilitate owner interactions. Voting mechanisms may be implemented for major property decisions. The friction point removal may enhance owner satisfaction and reduce operational complexity.

Another additional step may include data value creation may be enhanced through comprehensive tracking and analysis. Co-ownership behavior data may be collected and analyzed over time. Community dynamics data may be tracked to assess relationship quality among co-owners. Financial performance data may be monitored to evaluate investment returns. Predictive models may be developed to forecast future property performance. Benchmarking data may be generated to compare properties and identify best practices. The enhanced data value creation may provide insights to improve future property development and management decisions.

Another additional step may include repeatable participation models may be established to enable scalable operations. Standardized processes may be documented for all stages of fractional property development and management. Training materials may be created to enable consistent execution across multiple properties. Quality metrics may be established to measure process performance. Continuous improvement processes may be implemented to refine operations over time. The repeatable participation models may enable rapid expansion of fractional property operations.

Another additional step may include predictable achieved through standardization and automation. Transaction timelines may be established based on historical performance data. Success rates may be projected based on qualification criteria and matching algorithms. Financial returns may be forecasted based on property characteristics and market conditions. Risk factors may be identified and quantified. The predictable outcomes may enable informed decision-making by property developers and investors.

The method 800 may end at step 950. The method 800 may be repeated for additional properties as fractional property operations may expand. The method 800 may incorporate continuous improvements based on accumulated experience and data analysis. The method 800 may adapt to changing market conditions and regulatory requirements. The method 800 may provide a comprehensive framework for fractional property investment operations that may integrate operational intelligence and automation throughout the property lifecycle.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Systems, methods and computer program products are provided. In the detailed description herein, references to “various embodiments”, “one embodiment”, “an embodiment”, “an example embodiment”, and the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments, and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

Since many modifications, variations, and changes in detail can be made to the described preferred embodiments of the subject matter, it is intended that all matters in the foregoing description and shown in the accompanying drawings be interpreted as illustrative and not in a limiting sense. Thus, the scope of the subject matter should be determined by the appended claims and their legal equivalence.

What is claimed is:

1. A fractional-interest real property investment computing system, comprising:
a processor configured to execute computer-readable instructions; and a computer memory coupled to the processor and having computer executable instructions stored thereon that, when executed by the processor, cause:
a first database to store identities of a plurality of buyers qualified to purchase a fractionalized interest in a real property interest;
a second database to store information about a plurality of properties having fractionalized interests;
a matching engine to align one or more fractionalized interests with one of more qualified fractional buyers;
an underwriting engine to facilitate underwriting for each of the fractional qualified buyers matched to a fractionalized interest; and
a recordation engine to facilitate recordation of ownership of each fractional owner of one or more respective fractionalized interests after a completion of a financial transaction to acquire the one or more respective fractionalized interests.

2. The fractional-interest real property investment computing system of claim 1, wherein the qualified fractional buyers further comprise at least one qualified fractional buyer having a right to occupy the respective fractionalized interest.

3. The fractional-interest real property investment computing system of claim 1, wherein the qualified fractional buyers further comprise at least one qualified fractional buyer having no right to occupy the respective fractionalized interest.

4. The fractional-interest real property investment computing system of claim 1, wherein the qualified fractional buyers further comprise at least one qualified fractional buyer having a right to occupy the respective fractionalized interest and at least one qualified fractional buyer having a right to occupy the respective fractionalized interest.

5. The fractional-interest real property investment computing system of claim 1, wherein each fractional ownership interest corresponds to a specific exclusive portion of a property having fractionalized interests.

6. The fractional-interest real property investment computing system of claim 1, wherein at least one fractional ownership interest corresponds to a non-exclusive portion of a property having fractionalized interests.

7. The fractional-interest real property investment computing system of claim 1, wherein the property having fractionalized interest comprises at least one fractional ownership interest corresponding to a specific exclusive portion of the property and at least one fractional ownership interest corresponding to a specific non-exclusive portion of the property.

8. The fractional-interest real property investment computing system of claim 1, wherein the computer memory comprises further computer executable instructions stored thereon that, when executed by the processor, cause:
the second database to store identities of a plurality of sellers qualified to sell a fractionalized interest in a real property interest;
the matching engine to align one or more fractionalized buyers with one of more qualified fractional sellers;
the underwriting engine to facilitate underwriting for each of the fractional qualified buyers matched to a fractionalized seller; and
the recordation engine to facilitate recordation of transfer of ownership from each fractional seller to a respective fractional buyer after a completion of a financial transaction to acquire the one or more respective fractionalized interests.

9. The fractional-interest real property investment computing system of claim 1, wherein the computer memory comprises further computer executable instructions stored thereon that, when executed by the processor, cause:
the second database to store information about a plurality of properties having a potential to become properties with fractionalized interests;
the financing engine facilitate a financing instrument for acquisition a potential fractionalized interest property;
the recordation engine facilitating recording change in ownership interest for the potential fractionalized property transitioning to two or more fractionalized interests; and
the second database updating stored information about the potential fractionalized property to indicate a property with fractionalized interests.

10. The fractional-interest real property investment computing system of claim 9, wherein the computer memory comprises further computer executable instructions stored thereon that, when executed by the processor, cause automated financial transactions for rents and/or fees due for one or more fractionalized interest.

11. The fractional-interest real property investment computing system of claim 9, wherein the computer memory comprises further computer executable instructions stored thereon that, when executed by the processor, cause automated financial transactions for property taxes and mortgage payments.

12. The fractional-interest real property investment computing system of claim 9, wherein the computer memory comprises further computer executable instructions stored thereon that, when executed by the processor, cause the financing engine to initiate a contractual relationship with a third-party construction entity to accomplish construction for a transition of the potential fractionalized property to a fractionalized property.

13. A fractional-interest real property investment computing method, comprising:
in a networked computing environment, executing computer readable instructions stored on one or more computer memories in the computer network using one or more computer processors in the networked computing environment, that, when executed cause:
storing identities of a plurality of buyers qualified to purchase a fractionalized interest in a real property interest in a first database;
storing information about a plurality of properties having fractionalized interests in a second database;
matching one or more fractionalized interests with one of more qualified fractional buyers using a computer-based matching engine;
establishing financial underwriting for each of the fractional qualified buyers matched to a fractionalized interest using a computer-based financial engine; and
recording ownership of each fractional owner of one or more respective fractionalized interests after a completion of a financial transaction to acquire the one or more respective fractionalized interests using a computer-based recordation engine.

14. The fractional-interest real property investment computing method of claim 13, wherein the qualified fractional buyers further comprise at least one qualified fractional buyer having a right to occupy the respective fractionalized interest.

15. The fractional-interest real property investment computing method of claim 13, wherein the qualified fractional buyers further comprise at least one qualified fractional buyer having no right to occupy the respective fractionalized interest.

16. The fractional-interest real property investment computing method of claim 13, wherein the qualified fractional buyers further comprise at least one qualified fractional buyer having a right to occupy the respective fractionalized interest and at least one qualified fractional buyer having a right to occupy the respective fractionalized interest.

17. The fractional-interest real property investment computing method of claim 13, further comprises causing:
storing identities of a plurality of sellers qualified to sell a fractionalized interest in a real property interest in the second database;
matching one or more fractionalized buyers with one of more qualified fractional sellers using the matching engine;
facilitating financing underwriting for each of the fractional qualified buyers matched to a fractionalized seller using the financing engine; and
recording transfer of ownership from each fractional seller to a respective fractional buyer after a completion of a financial transaction to acquire the one or more respective fractionalized interests using the recordation engine.

18. The fractional-interest real property investment computing method of claim 17, further comprises causing:
storing information about a plurality of properties having a potential to become properties with fractionalized interests in the first database;
facilitating a financing instrument for acquisition a potential fractionalized interest property via a third-party banking computer in the networked computing environment;
recording a change in ownership interest for the potential fractionalized property transitioning to two or more fractionalized interests using a recordation engine; and
updating stored information in the second database about the potential fractionalized property to indicate a property with fractionalized interests.

19. The fractional-interest real property investment computing method of claim 17, further comprises causing automated financial transactions for property taxes and mortgage payments corresponding to at least one fractionalized property interest.

20. The fractional-interest real property investment computing method of claim 17, further comprises causing initiating a contractual relationship with a third-party construction entity to accomplish construction for a transition of the potential fractionalized property to a fractionalized property.

21. A fractional-interest real property investment computing system with automated recordation and operational intelligence, comprising:
a processor configured to execute computer-readable instructions; and
a computer memory coupled to the processor and having computer executable instructions stored thereon that, when executed by the processor, cause:
an artificial intelligence discovery engine to identify properties suitable for fractionalization by analyzing property data from multiple sources and applying machine learning algorithms to generate a ranked list of candidate properties;
a property database to store property data for identified candidate properties comprising property addresses, parcel numbers, current ownership information, physical characteristics, zoning classifications, and market value estimates;
an artificial intelligence design engine to generate optimal fractionalization configurations for candidate properties by analyzing property layouts, evaluating multiple potential configurations, and selecting a configuration that maximizes economic viability;
a financing optimization engine to identify optimal financing structures by analyzing available financing options from multiple lenders and selecting a financing structure that minimizes costs and maximizes returns;
a lifecycle operations engine to manage ongoing operations of fractionalized properties by tracking maintenance schedules, coordinating with service providers, and allocating maintenance costs among fractional owners;
a compliance automation engine to ensure regulatory compliance by monitoring applicable regulations, tracking permit requirements, and generating compliance reports; and
a recordation engine to facilitate recordation of ownership transfers with governmental recording authorities.

22. The fractional-interest real property investment computing system of claim 21, wherein the artificial intelligence discovery engine evaluates property characteristics comprising location, size, configuration, and zoning to assess suitability for fractionalization.

23. The fractional-interest real property investment computing system of claim 21, wherein the artificial intelligence design engine considers building codes, accessibility requirements, and safety regulations when generating fractionalization configurations.

24. The fractional-interest real property investment computing system of claim 21, wherein the financing optimization engine evaluates construction financing terms comprising interest rates, fees, and repayment schedules.

25. The fractional-interest real property investment computing system of claim 21, wherein the lifecycle operations engine generates work orders for maintenance and repair activities.

26. The fractional-interest real property investment computing system of claim 21, wherein the compliance automation engine initiates permit renewal processes before permits expire.

27. The fractional-interest real property investment computing system of claim 21, wherein the computer memory comprises further computer executable instructions stored thereon that, when executed by the processor, cause:
a multi-party coordination engine to facilitate interactions among multiple fractional owners by managing communication channels, coordinating decision-making processes, and tracking voting on property-related decisions.

28. The fractional-interest real property investment computing system of claim 27, wherein the multi-party coordination engine resolves conflicts between fractional owners through automated mediation protocols.

29. The fractional-interest real property investment computing system of claim 21, wherein the computer memory comprises further computer executable instructions stored thereon that, when executed by the processor, cause:
a data analytics engine to analyze data related to fractional property ownership and operations by tracking co-ownership behavior patterns, analyzing community dynamics, and evaluating financial performance metrics.

30. The fractional-interest real property investment computing system of claim 29, wherein the data analytics engine generates predictive models for property value appreciation and investment returns.

31. The fractional-interest real property investment computing system of claim 21, wherein the computer memory comprises further computer executable instructions stored thereon that, when executed by the processor, cause:
a platform execution engine to provide a standardized framework for fractional property transactions by implementing repeatable processes and maintaining templates for legal documents and financial instruments.

32. The fractional-interest real property investment computing system of claim 21, wherein the computer memory comprises further computer executable instructions stored thereon that, when executed by the processor, cause:
a self-learning system engine to continuously improve system performance by analyzing successful and unsuccessful transactions, adjusting matching algorithms, and refining property valuation models.

33. The fractional-interest real property investment computing system of claim 32, wherein the self-learning system engine updates underwriting criteria based on payment performance and default rates.

34. The fractional-interest real property investment computing system of claim 21, wherein the artificial intelligence discovery engine communicates with external data sources through a computing network to obtain market data, property listings, and demographic information.

35. The fractional-interest real property investment computing system of claim 21, wherein the artificial intelligence design engine generates design specifications comprising floor plans showing division of spaces and specifications for modifications required to implement fractionalization.

36. The fractional-interest real property investment computing system of claim 21, wherein the financing optimization engine calculates total financing costs for different financing structures and projects returns on investment for different financing approaches.

37. The fractional-interest real property investment computing system of claim 21, wherein the lifecycle operations engine tracks property condition and identifies repair needs.

38. The fractional-interest real property investment computing system of claim 21, wherein the compliance automation engine verifies that property modifications comply with applicable regulations.

39. The fractional-interest real property investment computing system of claim 21, wherein the computer memory comprises further computer executable instructions stored thereon that, when executed by the processor, cause:
a behavioral tracking database to store data regarding fractional owner behaviors comprising payment histories, property usage patterns, and interaction patterns with other owners;
a community dynamics database to store information about interactions among fractional owners comprising communication frequency, conflict incidents, and satisfaction surveys; and
a financial performance database to store financial data for fractional properties comprising property values, rental income, expense allocations, and return on investment metrics.

40. The fractional-interest real property investment computing system of claim 21, wherein the recordation engine communicates with a government recordation computing device to file ownership changes and retrieve recorded documents.

41. A fractional-interest real property investment computing method with automated recordation and operational intelligence, comprising:
in a networked computing environment, executing computer readable instructions stored on one or more computer memories in the computer network using one or more computer processors in the networked computing environment, that, when executed cause:
executing an artificial intelligence discovery process to identify properties suitable for fractionalization by analyzing property data from multiple sources and applying machine learning algorithms to generate a ranked list of candidate properties;
storing property data for identified candidate properties in a property database;
executing an artificial intelligence design process to generate optimal fractionalization configurations for candidate properties by analyzing property layouts and selecting a configuration that maximizes economic viability;
executing a financing optimization process to identify optimal financing structures by analyzing available financing options from multiple lenders;
initiating a lifecycle operations process to manage ongoing property operations by establishing maintenance schedules and coordinating with service providers;
executing a compliance automation process to ensure regulatory compliance by monitoring applicable regulations and tracking permit requirements; and
facilitating recordation of ownership transfers with governmental recording authorities using a recordation engine.

42. The fractional-interest real property investment computing method of claim 41, wherein executing the artificial intelligence discovery process comprises evaluating property characteristics comprising location, size, configuration, and zoning.

43. The fractional-interest real property investment computing method of claim 41, wherein executing the artificial intelligence design process comprises considering building codes, accessibility requirements, and safety regulations.

44. The fractional-interest real property investment computing method of claim 41, wherein executing the financing optimization process comprises evaluating construction financing terms comprising interest rates, fees, and repayment schedules.

45. The fractional-interest real property investment computing method of claim 41, wherein initiating the lifecycle operations process comprises generating work orders for maintenance and repair activities.

46. The fractional-interest real property investment computing method of claim 41, wherein executing the compliance automation process comprises initiating permit renewal processes before permits expire.

47. The fractional-interest real property investment computing method of claim 41, further comprising:
executing a multi-party coordination process to facilitate interactions among multiple fractional owners by managing communication channels and coordinating decision-making processes.

48. The fractional-interest real property investment computing method of claim 47, wherein executing the multi-party coordination process comprises resolving conflicts between fractional owners through automated mediation protocols.

49. The fractional-interest real property investment computing method of claim 41, further comprising:
executing a data analytics process to analyze data related to fractional property ownership and operations by tracking co-ownership behavior patterns and evaluating financial performance metrics.

50. The fractional-interest real property investment computing method of claim 49, wherein executing the data analytics process comprises generating predictive models for property value appreciation and investment returns.

51. The fractional-interest real property investment computing method of claim 41, further comprising:
implementing a platform execution process to provide a standardized framework for fractional property transactions by implementing repeatable processes.

52. The fractional-interest real property investment computing method of claim 41, further comprising:
executing a self-learning process to continuously improve system performance by analyzing transaction outcomes and adjusting system algorithms.

53. The fractional-interest real property investment computing method of claim 52, wherein executing the self-learning process comprises updating underwriting criteria based on payment performance and default rates.

54. The fractional-interest real property investment computing method of claim 41, wherein executing the artificial intelligence discovery process comprises communicating with external data sources through a computing network to obtain market data.

55. The fractional-interest real property investment computing method of claim 41, wherein executing the artificial intelligence design process comprises generating design specifications comprising floor plans showing division of spaces.

56. The fractional-interest real property investment computing method of claim 41, wherein executing the financing optimization process comprises calculating total financing costs for different financing structures.

57. The fractional-interest real property investment computing method of claim 41, wherein initiating the lifecycle operations process comprises tracking property condition and identifying repair needs.

58. The fractional-interest real property investment computing method of claim 41, wherein executing the compliance automation process comprises verifying that property modifications comply with applicable regulations.

59. The fractional-interest real property investment computing method of claim 41, further comprising:
storing data regarding fractional owner behaviors in a behavioral tracking database;
storing information about interactions among fractional owners in a community dynamics database; and
storing financial data for fractional properties in a financial performance database.

60. The fractional-interest real property investment computing method of claim 41, wherein facilitating recordation comprises communicating with a government recordation computing device to file ownership changes.
